(19) United States
(12) Patent Application Publication
(10) Pub. No.: US 2019/0275830 A1
(43) Pub. Date: Sep. 12, 2019

(54) Magnetic Display System With Writable Layers

(71) Applicant: Deetz Family, LLC, Mendon, MA (US)

(72) Inventors: Victoria Rose Deetz, Mendon, MA (US); Dayton J. Deetz, Mendon, MA (US)

(21) Appl. No.: 16/302,914

(22) PCT Filed: May 18, 2017
(86) PCT No.: PCT/US2017/033324

§ 371 Date: Nov. 19, 2018

Related U.S. Application Data
(60) Provisional application No. 62/338,097, filed on May 18, 2016.

(51) Int. Cl. B43L 1/00; G09F 7/04; B43L 1/04

(52) U.S. Cl. CPC B43L 1/008; B43L 1/045; G09F 7/04

(57) ABSTRACT

A magnetic information sharing system includes a magnetic writable system having a writable outer surface, and a plurality of writable layers having magnetic receptive properties, wherein the plurality of writable layers are overlaid on the magnetic writable system and are held thereon via magnetic force, and wherein each of the plurality of writable layers has a writable outer surface. A method of displaying information includes the steps of placing a magnetic writable system on a flat surface, recording information on a writable outer surface of the magnetic writable system, overlaying at least one writable layer onto the magnetic writable system, the writable layer comprising material having magnetic receptive properties, and recording information on the writable layer.

### FIELD OF THE INVENTION

The invention relates to a magnetic wall system, and in particular, to a system including a series of layers that are placed on a wall or another flat surface, wherein the layers include a magnetic information display system and at least one writable layer placed on top of the magnetic information display system.

### BACKGROUND OF THE INVENTION

Print media products including magnetic properties are often prepared by applying a magnetic receptive coating to one side of a commercially extruded film after the extrusion process. These products have met with good commercial success.

One such system is disclosed in U.S. Pat. No. 8,747,996 (the '996 patent) entitled Magnetic Graphic Wall System. The '996 provided a very good system for hanging printed images on a wall, for example, for applications in layering wallpapers with printed images. The success of the system embodied in the '996 patent has led to the issue of seeking to secure other objects to a wall, such as writable bulletin board-like layers.

For example, in office and education settings, bulletin boards are widely used for sharing information, sending reminders, and decorating. Typical bulletin boards are cork boards or magnetic boards, which necessarily require the use of push pins or small magnetic heads in various forms (e.g., buttons, clips, or push pins) to hold up papers or other things on the boards for display. Magnetic boards can also be equipped with dry-erase surfaces for customers to directly write messages on the surface. Customers may also employ traditional “post it note technology,” i.e., an adhesive paper system, wherein the customers stick post-it notes on a bulletin board for displaying information thereon. The post it notes are useful for providing highlighted and/or changed information on top of the information already presented on the board. However, the post-it notes loosely hang on the board with only part of the notes “sticking” to the board. Often the post-it notes undesirably fall from the board due to insufficient adhesiveness between the board and the notes. As such, the adhesive paper post-it type system does not provide a reliable solution for effective information sharing.

Therefore, there exists a need for a more reliable system for sharing information in office and educational settings that ensures secure adhesion between the writable notes and the substrate writable board or layer and that is highly customizable and user-friendly.

### SUMMARY OF THE INVENTION

What is desired then, is a system and method for securing writable layers to a wall purely by magnetic interaction that ensures a secured adhesion thereto.

It is also desired to provide a system and method that provides for a highly customizable information display and sharing system that is secured to any wall surface and can be easily rearranged and reused.

These and other objectives are achieved by providing a magnetic information sharing system that includes a magnetic writable system having a writable outer surface, and a plurality of writable layers having magnetic receptive properties, wherein the plurality of writable layers are overlaid on the magnetic writable system and are held thereon via magnetic force, and wherein each of the plurality of writable layers has a writable outer surface.

In certain embodiments, the writable outer surface of the magnetic writable system has at least one image printed thereof.

In some embodiments, the writable outer surface of the magnetic writable system is a dry-erase surface. In additional embodiments, the writable outer surface of the magnetic writable system is a chalk-receiving surface.

In certain embodiments, the magnetic writable system includes material having magnetic receptive properties. In some of these embodiments, the system also includes a base layer of magnetic receptive coating applied to a flat surface and a second layer of magnetic sheet being overlaid onto the first layer. In additional embodiments, the magnetic writable system is overlaid onto the second layer.

In some cases, the magnetic writable system includes a magnetic sheet.

In certain embodiments, the writable outer surface of the plurality of writable layers is a dry-erase surface. In additional embodiments, the writable outer surface of the plurality of writable layers is a chalk-receiving surface.

In some embodiments, at least one of the plurality of writable layers has printed images on the outer surface thereof.

In certain embodiments, each of the plurality of writable layers has a perimeter that is smaller than a perimeter of the magnetic writable system.

In some cases, each of the plurality of writable layers may be freely removed from the outer surface of the magnetic writable system and reattached to the magnetic writable system at substantially any location along its outer surface.

In certain embodiments, the plurality of writable layers includes a first writable layer laid over the magnetic writable system, a second writable layer laid over the first writable layer and at least one additional writable layer laid over the second writable layer. In some preferred embodiments, up to five writable layers are stacked on top of each other

In an additional embodiment, a magnetic information sharing system includes a magnetic writable system having a writable outer surface, and a plurality of writable layers having magnetic receptive properties, wherein the plurality of writable layers are overlaid on the magnetic writable system and are held thereon via magnetic force, wherein each of the plurality of writable layers has a writable outer surface, and wherein each of the plurality of writable layers is a sheet in a range of from about 5 mil to about 20 mil. In some embodiments, the writable layers are non-dry erase, but have a different writable and/or printable surface.

In some embodiments, the sheet is selected to be an 11 mil sheet.

A magnetic information sharing system is also provided, including a magnetic system with a decorative outer layer with a decorative pattern printed thereon, and a plurality of layers having magnetic receptive properties, wherein the plurality of layers are overlaid on the magnetic system and are held thereon via magnetic force, and wherein each of the plurality of layers has a decorative outer surface.

In some embodiments, the decorative outer layer of the magnetic system is configured to be writable. In additional embodiments, the decorative outer surface of the plurality of layers is configured to be writable.

A method of displaying information is also provided, including the steps of placing a magnetic writable system on a flat surface, recording information on a writable outer surface of the magnetic writable system, overlaying at least one writable layer onto the magnetic writable system, the at least one writable layer including material having magnetic receptive properties, and recording information on the at least one writable layer.

In some embodiments, the method also includes the step of erasing the recorded information from the writable outer surface of the magnetic writable system. In additional embodiments, the method further includes the step of erasing the recorded information from the writable outer surface of the at least one writable layer.

In certain cases, the method also includes the steps of removing the at least one writable layer from the magnetic writable system and overlaying the writable layer onto a different portion of the magnetic writable system.

In some embodiments, the method also includes the step of overlaying at least one additional writable layer over the at least one writable layer, wherein the at least one additional writable layer includes material having magnetic receptive properties. In certain of these embodiments, the method further includes the step of recording information on a writable outer surface of the at least one additional writable layer.

Other objects of the invention and its particular features and advantages will become more apparent from consideration of the following drawings and accompanying detailed description.

### BRIEF DESCRIPTION OF THE DRAWINGS

FIG. 1 is a perspective view of an information sharing system of the present invention, including a magnetic writable system and a plurality of writable layers.

FIG. 2 is an exploded perspective view of the information sharing system according to FIG. 1, including two attachment layers for attachment of the system to a wall.

FIG. 3 is a front perspective view of the information sharing system according to FIG. 1, illustrating the plurality of writable layers being moved on a surface of the magnetic writable system.

FIG. 4 is a front perspective view of the information sharing system according to FIG. 1, illustrating multiple writable layers stacked on top of each other.

### DETAILED DESCRIPTION OF THE INVENTION

This invention provides an information display system which utilize magnetic receptive writable layers in conjunction with a magnetized base to display information on the writable surfaces of the writable layers. The writable layers have a magnetic receptive coating on the back which holds the writable layers to the magnetized base. In some advantageous embodiments, the magnetized base is a magnetic board for displaying information. The system allows a user to add additional layers of the writable layers on the magnetized base performing post-it note like functions.

Referring now to the drawings, wherein like reference numerals designate corresponding structure throughout the views.

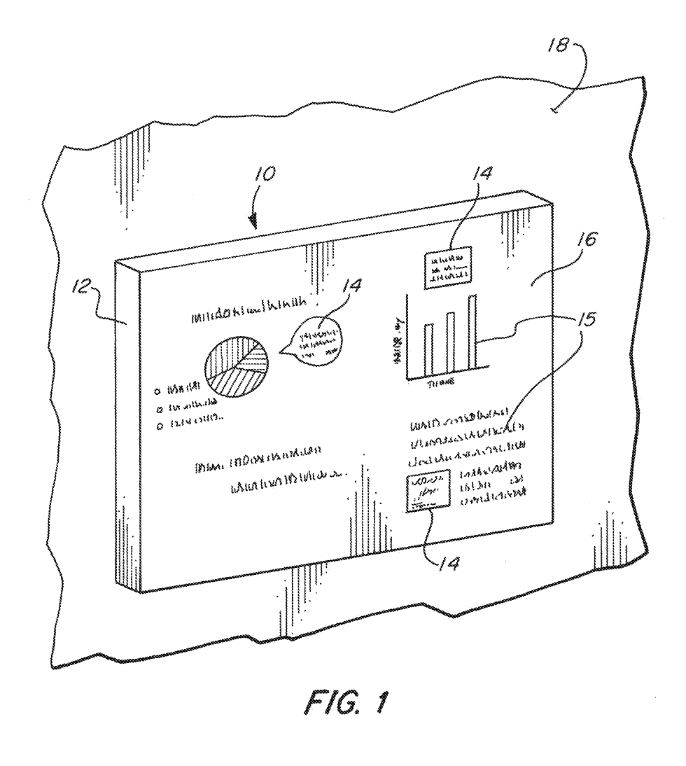

FIG. 1 illustrates the writable system for displaying and sharing information in accordance with the invention. The system 10 includes a magnetic system 12 affixed to any flat surface 18. In some advantageous embodiments, the system 12 is affixed to a wall in a board room in an office or educational setting. The magnetic system 12 may be of any size and/or shape depending upon a particular customer's needs. The system 10 further includes a plurality of writable layers 14 laid over an outer surface 16 of the writable board 12.

The outer surface of the board 12 has a layer of writable material which allows a user to record and display various information 15 on the board. In some embodiments, the writable surface 16 is a “dry-erase” or “dry-wipe” surface which allows for non-permanent recordation of information on the surface. The information can then be erased or wiped off, and new information can be recorded. The dry-erase surface 16 is made with any suitable glossy materials, such as melamine, painted steel or aluminum, laminate, ceramic or tempered glass. The markings may be made by any suitable writing device. In one example, a non-permanent marker that uses an erasable ink that adheres to the writing surface without binding to or being absorbed by it is used to make markings on the dry-erase surface, A permanent marker or another writing device may also be used. The markings are then wiped off by an eraser made with any suitable material. Water or a special cleaner liquid may also be used to facilitate removal of the markings from the writable surface 16.

In additional embodiment, the writable surface 16 of the board 12 is a blackboard or chalkboard surface. This is essentially a reusable writing surface that accepts markings made with chalk material, which can then be erased. The chalkboard surface comprises a black or dark grey slate stone, chalk paint or other suitable materials.

In additional embodiments, the outer surface 16 of the board 12 may not be writable, but instead may have a decorative pattern or any other indicia printed thereon.

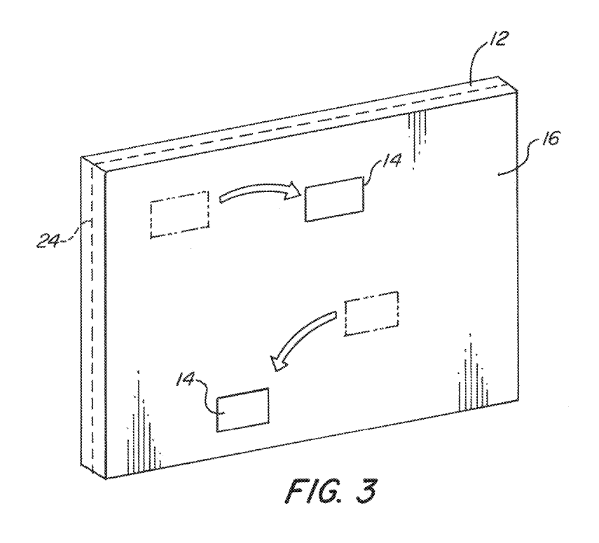

As illustrated in FIG. 3, the board 12 has a certain thickness to accommodate a sheet of magnetic material 24 placed inside the board 12. As an example, the magnetic sheet may comprise a range from 15 to 40 mil and in a preferred embodiment, comprising a 28 mil, rubber extruded sheet magnet and may have a specific polarity line spacing. In particular, the magnetic sheet 24 may be a ferrite-based magnetic system, in which unlike stronger rare-earth permanent magnets, the multipole nature of ferrite magnets does not emit a strong magnetic field into its environment.

The magnetic sheet 24 generates a magnetic force that works to hold the writable layers 14 on the surface of the board 12, as discussed in more detail below. The writable board 12 is affixed to the wall 18 by hanging it on the wall via any suitable connector, such as hooks, screws, etc.

In another advantageous embodiment, the wall surface 18 is painted with a magnetic receptive primer coating(s). This way, the magnetic force between the magnetic receptive primer on the wall 18 and the magnetic sheet 24 in the writable board 12 retain the board on the wall. It is contemplated that a typical color coating (i.e., a white color) may be applied over the magnetic receptive primer coating(s) to provide a natural and/or a colorful look to the wall surface 18. In this manner, the wall surface 18 would look “normal” when it is not layered with the writable board 12. Such magnetic receptive primer treated wall surface may also be referred to as an “activated” wall surface.

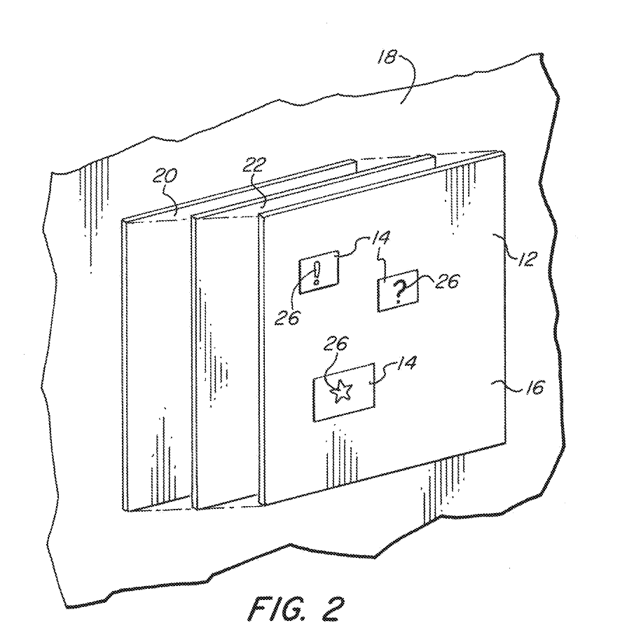

In an additional embodiment illustrated in FIG. 2, the writable board 12 does not contain a sheet of magnetic material, but instead has a coating of magnetic receptive material applied to the back side thereof. This allows for the board 12 to be much thinner and simpler in construction. In this embodiment, the writable board 12 is in a form of a thin sheet that is rolled out over the wall surface 18. The sheet may be of any size and/or shape and may be easily cut to a desired shape by a customer.

In the embodiment of FIG. 2, the system 10 further includes separate magnetic sheet layer 22 positioned between the writable board 12 and the magnetic receptive coating 20 applied to the wall surface 18. In some embodiments, the magnetic sheet 22 is a double-sided magnet that functions to generate a magnetic force to hold the sheet 22 to the magnetic receptive coating 20, which in turn holds the magnetic sheet 22 to the wall 18, and to also affix the writable board 12 to the magnetic sheet 22. In other embodiments, the magnetic sheet 22 is affixed to the wall with any suitable adhesive and the magnetic receptive coating 20 on the wall surface is not required. The magnetic sheet 22 may be made with the same material and/or have the same properties as described above with respect to the magnetic sheet 24.

The writable board sheet 12 in FIG. 2 can be made of paper, plastic, fiber, etc. The magnetic receptive coating on the back of the board sheet 12 is provided to be in direct contact with the magnetic sheet layer 22. The front writable surface 16 of the board sheet 12 is made with any suitable coating that allows for non-permanent markings to be made on the surface, as described above. The writable surface 16 can incorporate one or more colors and can have one or more images printed thereon.

The system 10 further incorporates the plurality of layerable and reusable writable layers 14, which are laid over the outer surface 16 of the writable board 12. The writable layers preferably mimic traditional paper post-it notes and incorporate the same colors and shapes as the traditional post-it notes. The outer surface of the writable layers 14 can incorporate different designs and colors, which can be easily customized. Because the writable layers 14 are to be used with the writable board 12, the writable layers are preferably designed to match the writable board. The layers 14 can also have one or more images 26 printed thereon, as illustrated in FIG. 2. The layer 14 can be pre-made and/or cut by the customer into various sizes and shapes to fit customer's needs.

The writable layers are made with a thin sheet of material with a layer of magnetic receptive coating applied to the back side. The sheet of material may comprise a range from 5 to 20 mil and in a preferred embodiment, comprising 11 mil. The magnetic receptive coating is made of magnetic receptive particles, such as iron, magnetite, ferromagnetic, or any material that may be attracted to a magnet, but itself does not create a magnetic field. The magnetic receptive coating of the writable layers 14 interacts either with the magnetic sheet 24 placed inside the writable board 12, as shown in FIG. 3, or with the magnetic sheet layer positioned between the wall and the board 12, as shown in FIG. 3. This way, the writable layers 14 are removably but securely affixed to the writable surface 16 of the board 12.

The writable layers 14 also have a writable outer surface, such as a dry-erase or chalk receiving surface, as described above with respect to the writable surface 16 of the board 12. A user can write or draw any information on the writable surface of the layers 14 to supplement or comment on the information displayed on the writable board 12. The information is then erased from the layers 14 and the layers are reused. The writable layers 14 typically have a perimeter that is smaller than a perimeter of the writable board 12 and can be placed anywhere on the surface 16.

In additional embodiments, the outer surface of the layers 14 may not be writable, but instead may have a decorative pattern or other indicia printed thereon. In further embodiments, the outer surface of the layers 14 may be both writable and printable.

When in use, one or more of the writable layers 14 is layered on the surface 16 of the writable board 12. The magnetic force between the magnetic receptive coating of the writable layer 14 and the magnetic sheet of the board 12 or a separate magnetic sheet 22 allows the writable layer to smoothly spread and adhere to the writable board 12, forming a flat writable surface. This is a great advantage over the traditional post-it note technology because the post-it note no longer “hangs” on the magnet surface and thus eliminates the unintended loss of the note from the board. Another advantage of the present invention is that no push pins or magnet heads/clips are required for holding the writable layers. With proper design and color choice of the writable layer 14, the layer can seamlessly interface with the writable board 12. The information on the writable layer can cover and thus replace the information displayed on the writable board 12 or can be placed next to it and supplement it with additional information.

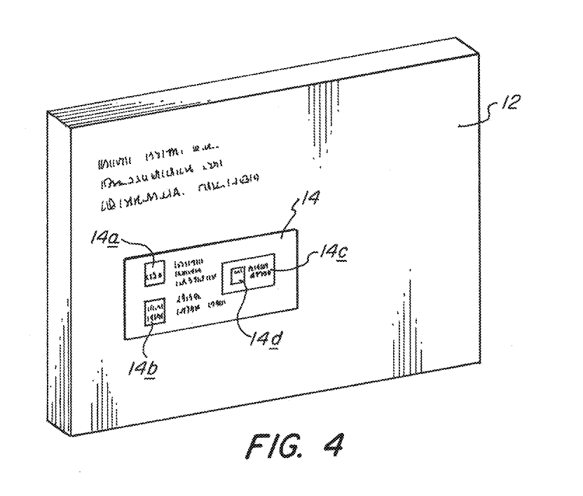

More than one sheet of the writable layers 14 can be stacked directly on top each other, as illustrated in FIG. 4. For example, the writable layer 14 is placed on the board surface 12 and secondary writable layers 14a, 14b, and 14c are placed on top of the layer 14. A tertiary writable layer 14d can be positioned on top of the secondary layer 14c. The magnetic force between the magnetic receptive material of the layers 14a-14d and the magnet sheet 24 or 22 is strong enough such that all layers remain securely affixed to the board surface. Preferably, up to four sheets of the writable layers are stacked on top of each other and securely held on the board surface. Such design allows for great flexibility in changing or supplementing information displayed on the writable board 12 in a use-friendly and efficient manner.

The magnetic receptive writable layers 14 are not attracted to each other. This allows the user to easily remove each of the writable layers 14 and move it to a different place on the writable board surface 16, as illustrated in FIG. 3, just like repositioning a traditional post-it note. To do that, a customer simply peels the writable layer 14 off from the writable board surface 16 and positions it at a different location on the board 12. The writable layers 14 are reusable as one can write or draw on the writable surface of the layers with a suitable writing device and later erase the writings or drawings numerous times, as desired. Advantageously, the present invention eliminates the need to keep buying paper post-it notes and sending the used post-it notes to the landfills.

Although the invention has been described with reference to a particular arrangement of parts, features and the like, these are not intended to exhaust all possible arrangements or features, and indeed many other modifications and variations will be ascertainable to those of skill in the art.

What is claimed is:

1. A magnetic information sharing system comprising:
a magnetic writable system comprising a writable outer surface; and
a plurality of writable layers having magnetic receptive properties;
wherein the plurality of writable layers are overlaid on the magnetic writable system and are held thereon via magnetic force; and
wherein each of the plurality of writable layers has a writable outer surface.

2. The system of claim 1, wherein the writable outer surface of the magnetic writable system has at least one image printed thereof.

3. The system of claim 1, wherein the writable outer surface of the magnetic writable system is a dry-erase surface.

4. The system of claim 1, wherein the writable outer surface of the magnetic writable system is a chalk-receiving surface.

5. The system of claim 1, wherein the magnetic writable system comprises material having magnetic receptive properties.

6. The system of claim 5, further comprising a base layer of magnetic receptive coating applied to a flat surface and a second layer of magnetic sheet being overlaid onto the first layer.

7. The system of claim 6, wherein the magnetic writable system is overlaid onto the second layer.

8. The system of claim 1, wherein the magnetic writable system comprises a magnetic sheet.

9. The system of claim 1, wherein the writable outer surface of the plurality of writable layers is a dry-erase surface.

10. The system of claim 1, wherein the writable outer surface of the plurality of writable layers is a chalk-receiving surface.

11. The system of claim 1, wherein at least one of the plurality of writable layers has printed images on the outer surface thereof.

12. The system of claim 1, wherein each of the plurality of writable layers has a perimeter that is smaller than a perimeter of the magnetic writable system.

13. The system of claim 1, wherein each of the plurality of writable layers may be freely removed from the outer surface of the magnetic writable system and reattached to the magnetic writable system at substantially any location along its outer surface.

14. The system of claim 1, wherein the plurality of writable layers comprises a first writable layer laid over the magnetic writable system, a second writable layer laid over the first writable layer and at least one additional writable layer laid over the second writable layer.

15. A magnetic information sharing system comprising:
a magnetic writable system comprising a writable outer surface and a magnetized sheet positioned under the writable outer surface; and
a plurality of writable layers having magnetic receptive properties;
wherein the plurality of writable layers are overlaid on the magnetic writable system and are held thereon via magnetic force exerted by the magnetized sheet;
wherein each of the plurality of writable layers has a writable outer surface; and
wherein each of the plurality of writable layers comprises a sheet in a range of from about 5 mil to about 20 mil.

16. The system of claim 15, wherein the sheet is selected to be an 11 mil sheet.

17. A magnetic information sharing system comprising:
a magnetic system comprising a decorative outer layer with a decorative pattern printed thereon; and
a plurality of layers having magnetic receptive properties;
wherein the plurality of layers are overlaid on the magnetic system and are held thereon via magnetic force; and
wherein each of the plurality of layers has a decorative outer surface.

18. The magnetic information sharing system of claim 17, wherein the decorative outer layer of the magnetic system is configured to be writable.

19. The magnetic information sharing system of claim 17, wherein the decorative outer surface of the plurality of layers is configured to be writable.

20. A method of displaying information comprising the steps of:
placing a magnetic writable system on a flat surface,
recording information on a writable outer surface of the magnetic writable system;
overlaying at least one writable layer onto the magnetic writable system, the at least one writable layer comprising material having magnetic receptive properties; and
recording information on the at least one writable layer.

21. The method of claim 20, further comprising the step of erasing the recorded information from the writable outer surface of the magnetic writable system.

22. The method of claim 20, further comprising the step of erasing the recorded information from the writable outer surface of the at least one writable layer.

23. The method of claim 20, further comprising the steps of removing the at least one writable layer from the magnetic writable system and overlaying the writable layer onto a different portion of the magnetic writable system.

24. The method of claim 20, further comprising the step of overlaying at least one additional writable layer over the at least one writable layer, wherein the at least one additional writable layer comprises material having magnetic receptive properties.

25. The method of claim 24, further comprising the step of recording information on a writable outer surface of the at least one additional writable layer.
